(19) United States
(12) Patent Application Publication
(10) Pub. No.: US 2016/0152275 A1
(43) Pub. Date: Jun. 2, 2016

(54) BOLTED CHASSIS FRAME FOR A MACHINE

(71) Applicant: Caterpillar Inc., Peoria, IL (US)

(72) Inventors: Kannan Rangaramanujam, Chennai (IN); Nirmal Goldwin, Bangalore (IN)

(73) Assignee: Caterpillar Inc., Peoria, IL (US)

(21) Appl. No.: 15/015,149

(22) Filed: Feb. 4, 2016

(51) Int. Cl. B62D 21/18; B62D 27/00; B62D 21/02

(52) U.S. Cl. CPC B62D 21/186; B62D 21/02; B62D 27/00

(57) ABSTRACT

A chassis frame for a machine has a rail assembly with a first side plate with a first outer surface, a second side plate with a second outer surface, a base plate and roof plates, connectable with the first and second side plates. A connection assembly connects the first side plate, base plate, second side plate, and roof plates, and has a first bracket assembly and a second bracket assembly. The first bracket assembly and the second bracket assembly include first portions and second portions. First portions connect to the base plate and the roof plates. Threaded fasteners extend into the second side plate and the first side plate and are routed through the second portions. Further, a sleeve positioned about the threaded fasteners extend from the first outer surface to the second outer surface, forming an interface respectively between the threaded fastener and the first and second side plate.

### TECHNICAL FIELD

The present disclosure generally relates to chassis frame of a machine. More particularly, the present disclosure relates to a bolted chassis frame for a Large Mining Truck.

### BACKGROUND

Construction machines such as Large Mining Trucks (LMTs), off-highway trucks, articulated trucks, etc., are used in mining and construction activities for loading, hauling, and unloading, a variety of materials. As examples, materials may include sand, rocks, gravel, mineral ores, other disintegrated particles, stone blocks, etc. Construction machines include dump bodies that facilitate transport of such materials. Dump bodies are generally supported on a frame of construction machines that provides the dump body with the requisite stiffness and strength to withstand a weight of the materials and the stresses of operation.

Frames applied conventionally include portions referred to as rail assemblies that bear a brunt of the load of the dump body. These rail assemblies are commonly produced as caked and welded structures. Over time, there is an increased chance of such structures to relatively quickly wear out, sustain deformations, develop fractured welds, misalignments, and other flaws, which although may seem minimalistic in the beginning, may prove to be consequential, eventually. Moreover, once such flaws are detected, a disassembly and replacement of such structures is needed, which is a costly and a tedious affair, involving considerable amount of man-hours that affect regular field operations.

Further, typical dump bodies include components such as hoist assemblies that facilitates a general movement of the dump body relative to the frame. Hoist assemblies are generally hydraulic based actuator units that are connected to the dump body at one end, while having another end connected to the frame. Each time a dump body is raised and lowered, typically, hoist assemblies impart a concentrated load on a portion of the rail assemblies to which the hoist assembly is connected. Given frequent dump body movement, it is generally required that both the hoist assembly and the frame possess requisite stiffness and strength. With casted and welded structures, however, it is generally a challenge to ascertain long term durability, as aforementioned.

As a result, it has been a longstanding desire for dump body makers and machine frame manufacturers to develop a construction configuration in rail assemblies that will withstand fatigue loads, be relatively easy to assemble, disassemble, service, re-install, and replace, and which may serve as due replacement to the otherwise wear prone rail assemblies. Additionally, it is desired that structural failures in rail assemblies be addressed relatively quickly and with lessened cost.

United States Publication 20070176406 discloses the use of a frame rail assembly that includes a spacer disposed between a first rail portion and a second rail portion. Further, a bolt assembly is described that retains the first rail portion to the second rail portion. Although the discussion of the '406 reference pertains to the construction and structural configurations of frame rail assembly, no discussions are included that pertain to the protection of the bolt assembly, and which is able to effectively divert a load path sustained by the frame during applications to any auxiliary portion or unit.

Accordingly, the system and method of the present disclosure solves one or more problems set forth above and other problems in the art.

### SUMMARY OF THE INVENTION

Various aspects of the present disclosure illustrate a chassis frame for a machine. The chassis frame includes a rail assembly with a first side plate that has a first outer surface. A base plate is included which is angularly connectable to the first side plate. Further, a second side plate with a second outer surface is angularly connectable to the base plate and positioned relatively parallely and symmetrically oppositely to the first side plate, across the base plate. One or more roof plates are angularly connectable with the second side plate and the first side plate. The one or more roof plates impart a substantially closed, box-shaped profile to the side rail assembly. At least a pair of connection assemblies facilitate connection between the series of the first side plate, the base plate, and the second side plate, and the series of the first side plate, the one or more roof plates, and second side plate. Each connection assembly among the at least a pair of connection assemblies include at least one first bracket assembly and at least one second bracket assembly. Each of the at least one first bracket assembly and the at least one second bracket assembly include first portions and second portions. First portions of each of the at least one first bracket assembly and the at least one second bracket assembly connect to one of the base plate and the one or more roof plates. Each connection assembly includes at least a pair of threaded fasteners. Each threaded fastener among the at least a pair of threaded fasteners extends into the first side plate and is routed till the second side plate respectively through the second portions of each of the at least one first bracket assembly and the at least one second bracket assembly. Each threaded fastener includes a sleeve positioned about each threaded fastener and extends from the first outer surface of the first side plate to the second outer surface of the second side plate. An arrangement of the sleeves form an interface between each threaded fastener and the first side plate and the second side plate.

### BRIEF DESCRIPTION OF THE DRAWINGS

FIG. 1 is a perspective view of a large mining truck installed with a frame with rail assemblies, in accordance with the concepts of the present disclosure;

FIG. 2 is a perspective view of the frame with the rail assemblies of FIG. 1, in accordance with the concepts of the present disclosure;

FIG. 3 is a perspective of one of the rail assemblies of FIG. 2, depicting structural details of the rail assembly, in accordance with the concepts of the present disclosure;

FIG. 4 is a close-up enlarged view of a portion of the rail assembly of FIG. 3, which shows details pertaining to the interconnection between multiple portions of the rail assembly of FIG, 3; and

FIG. 5 is an exemplary cross-sectional view of the rail assembly of FIG. 3, depicting further details of the connection between each of the portions of the rail assembly of FIG. 3.

### DETAILED DESCRIPTION

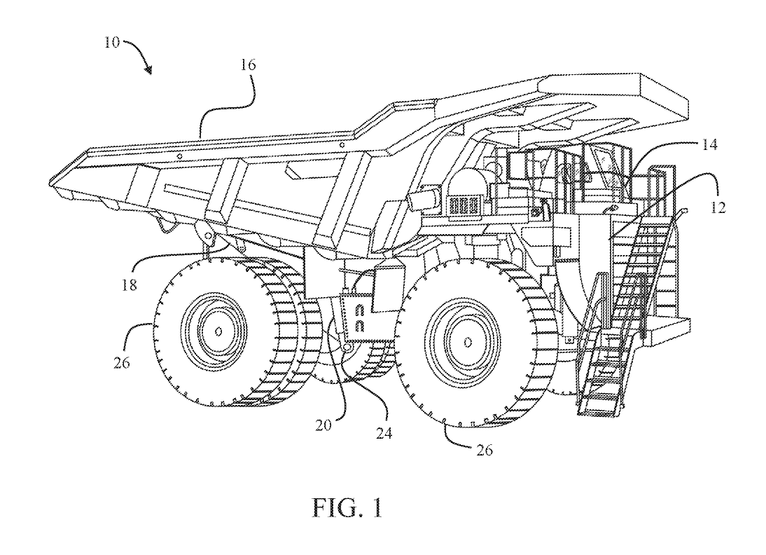

Referring to FIG. 1, a machine 10 is shown The machine 10 may be a construction machine, such as an off-highway truck, a dump truck, and/or a mining truck. The machine 10 includes an engine compartment 12, an operator cab 14, a dump body 16, and a chassis frame 18. The engine compartment 12 may house an engine (not shown) to power the machine 10. The operator cab 14 houses controls units that facilitate execution of various functions and controls of the machine 10, such as a movement of the dump body 16 relative to the machine 10. Wherever possible, the same reference numbers will be used throughout the drawings to refer to the same or like parts.

The dump body 16 is pivotally mounted to the chassis frame 18, as is customary. The dump body 16 may be configured to assist in hauling a variety of loads, such as a stone blocks, aggregate materials, and finer particles that include, but are not limited to, gravel, disintegrated rock particles, sand, soil, fine particulate matter, and/or other relatively small and discrete mass of solid materials.

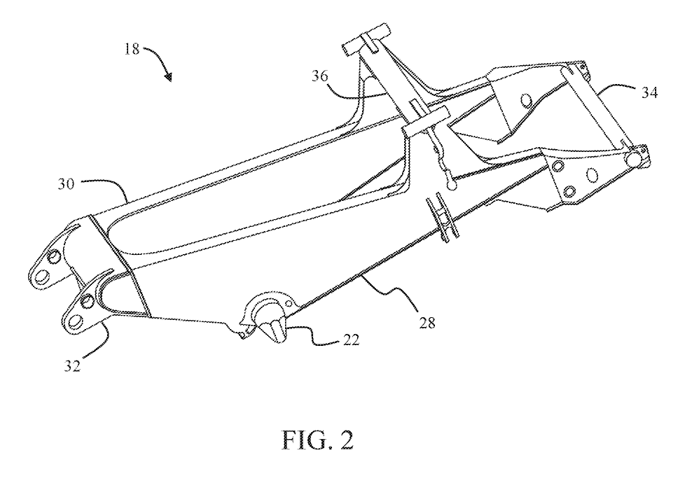

A hoist assembly 20 is provided below the dump body 16, and above the chassis frame 18, along an elevation of the machine 10, to manipulate the dump body 16 relative to the machine 10 (or the chassis frame 18). The hoist assembly 20 is pivotally connected to a frame portion 22 (see FIG. 2) of the chassis frame 18 at a first end 24, while a second end (not shown) of the hoist assembly 20 is pivotally and slidably engaged with a dump portion of the dump body 16. One or more mounting brackets (not shown) may ascertain a connection of the first end 24 and the second end (not shown) respectively to the frame portion 22 and the dump portion. In one implementation, the hoist assembly 20 is an actuator unit actuated by one of a hydraulic or a pneumatic energy source. Such actuator units enable a raising and lowering of the dump body 16 relative to the machine 10, generally constituting and defining the manipulation requirement. The hoist assembly 20 and the chassis frame 18 possess requisite stiffness and strength. However, it needs to be noted that the frame portion 22 and the dump portion (not shown) may sustain a maximum degree of load during a raising and lowering operation. As a result, the frame portion 22 is prone to twisting forces of operation that are commonly classified into vertical bending loading and longitudinal torsion loading.

Referring to FIG. 2, the chassis frame 18 is shown in greater detail. The chassis frame 18 is constructed from a conventionally available reinforced steel material. Such materials are incorporated to ensure the achievement of an optimized structural strength of the chassis frame 18, without the undue increase of the machine's weight, as increased weight generally corresponds to reduced efficiency. The chassis frame 18 is adapted to accommodate and support a weight of multiple units of the machine 10, such as that of the engine, transmission unit, driveline, powertrain, the dump body 16, operator cab 14, wheels 26, etc. Further, the chassis frame 18 is characterized with a generally limited ductility quotient that allows the chassis frame 18 to effectively sustain effects of vibratory operational conditions, while also accepting an appropriate volume and weight of a load into the dump body 16.

The chassis frame 18 includes members referred to as rail assemblies. In one illustrative embodiment, there are two rail assemblies shown, namely a first rail assembly 28 and a second rail assembly 30. The first rail assembly 28 and the second rail assembly 30 are generally parallely and evenly laid out members of the chassis frame 18. Collectively, the rail assemblies 28 and 30 may resemble a conventional ladder frame configuration applied in chassis of various machines and vehicles, characterized with one or more sequentially laid out connectors in between. Such connectors and sections in the chassis frame 18 include a rearward linkage 32, a forward linkage 34, and an elevated linkage 36.

For the purpose of this application and for ease in referencing, only a singular rail assembly (the first rail assembly 28) is described. However, it is envisioned that the second rail assembly 30 incorporates a structure and connection arrangements similar to what is described for the first rail assembly 28, in the forthcoming disclosure. Moreover, an applicability of the structure being described for the first rail assembly 28 is envisioned for the second rail assembly 30 as well. For ease in referencing, the first rail assembly 28 and the second rail assembly 30 may be collectively and simply referred to as rail assemblies 28 and 30.

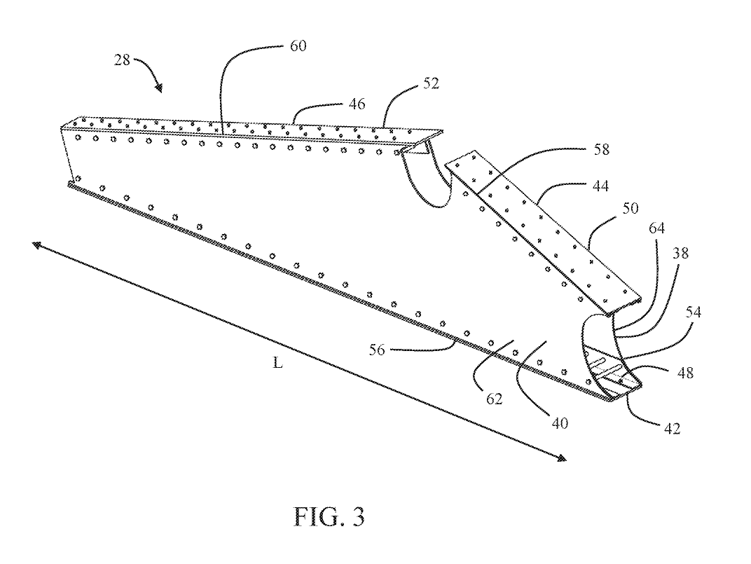

Referring to FIG. 3, the first rail assembly 28 is shown. For ease in understanding, the depiction of the first rail assembly 28 is upside-down relative to the view in FIG. 2. An integrated unit as defined by the first rail assembly 28 possesses a generally scalene triangular shaped structure, with generic extensions along an associated length, L, that impart an overall elongation to the chassis frame, as is customarily known. However, multiple other shapes, such as rectangular (cuboidal) shapes, stepped profiles, and other known configurations, as is conventionally applicable for chassis frames, may be contemplated. The first rail assembly 28 includes a first side plate 38, a second side plate 40, a base plate 42, a forward roof plate 44, and a rearward roof plate 46.

The first side plate 38 is a generally planarly constructed member with a requisite thickness to impart stiffness and strength to the overall structure of the chassis frame 18. The first side plate 38 is generally triangular shaped to fall in compliance with the overall triangular profile of the integrated unit defined by the first rail assembly 28. With such a profile, the first side plate 38 defines a first lower edge 48, a first forward upper edge 50, and a first rearward upper edge 52 (collectively, first edges 48, 50, 52). Further, the first side plate 38 has a first outer surface 54 and is perhaps secured with the connectors (each of the rearward linkage 32, the forward linkage 34, and the elevated linkage 36 (FIG. 2)) by one of welding, fastening, etc. The first side plate 38 may be manufactured by way of conventional forging operations, assumed with a series of rolling and finishing operation, so as to attain a planar shape and profile with requisite tolerances.

As with the first side plate 38, the second side plate 40 is also a generally planarly constructed member with a requisite thickness (similar to the thickness of the first side plate). The second side plate 40 is a general reproduction of the first side plate 38. Therefore, the second side plate 40 also includes a second lower edge 56, a second forward upper edge 58, and a second rearward upper edge 60 (collectively, second edges 56, 58, 60), as well. In congruence with the connection characteristics of the first side plate 38, the second side plate 40 may also be connected to the connectors (each of the rearward linkage 32, the forward linkage 34, and the elevated linkage 36) by welding, threaded fastening, for example. Further, the second side plate 40 has a second outer surface 62, similar to the first outer surface 54 defined by the first side plate 38.

The base plate 42 is relatively planar in shape and minimally trapezoidal along an extension, although a rectangular configuration is also possible. The base plate 42 is an extended piece of material, perhaps of high-grade steel, and is adapted to be connected to and along the first lower edge 48 and the second lower edge 56 respectively of the first side plate 38 and the second side plate 40. The base plate 42 is angularly connectable with the each of the first side plate 38 and the second side plate 40. This angular connection is assumed to be right angled, although allowable variations in this angular arrangement are possible. Across a width of the base plate 42, an ensuing position of the second side plate 40 is assumed to be relatively parallely and symmetrically opposed to the first side plate 38.

The forward roof plate 44 and the rearward roof plate 46 are also relatively planar components, adapted to respectively connect the first forward upper edge 50 to the second forward upper edge 58 and first rearward upper edge 52 to the second rearward upper edge 60, of the first side plate 38 and the second side plate 40. More particularly, the forward roof plate 44 is adapted to connect the first forward upper edge 50 to the second forward upper edge 58, whereas the rearward roof plate 46 is adapted to connect the first rearward upper edge 52 to the second rearward upper edge 60. These connections are assumed to be defined at substantial right angles. Although a design with a two roof plate (44 and 46) design has been disclosed here, embodiments may be contemplated where only a singular roof plate is used. Similarly, certain embodiments may hold more than two roof plates or multiple base plates, as well.

In particular, the forward roof plate 44, the rearward roof plate 46, and the base plate 42, facilitate a connect between the first edges 48, 50, 52 of the first side plate 38 and the second edges 56, 58, 60 of the second side plate 40. Effectively, the second side plate 40 and the first side plate 38 are connected to each other by way of the base plate 42 and the roof plates 44, 46. With each of these connections being defined at substantial right angles, a generally rigid closed box-shaped profile is imparted to the first rail assembly 28. This rigid closed box-shaped profile, defined along the triangular profile of the first rail assembly 28 further imparts a substantially prism-shaped configuration to the first rail assembly 28, thereby supplementing the robustness of the structure.

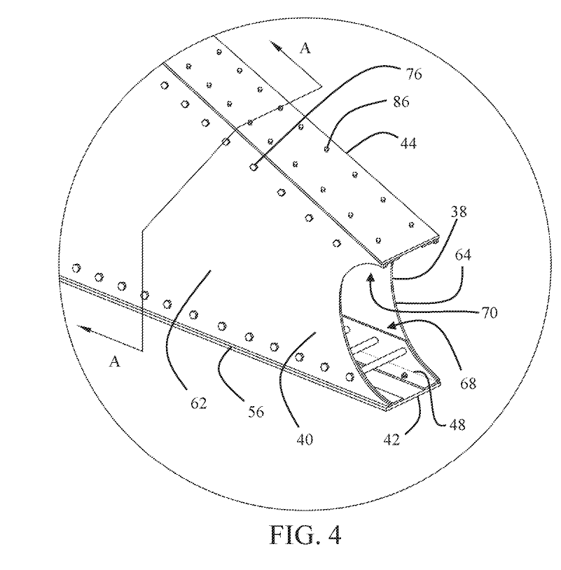

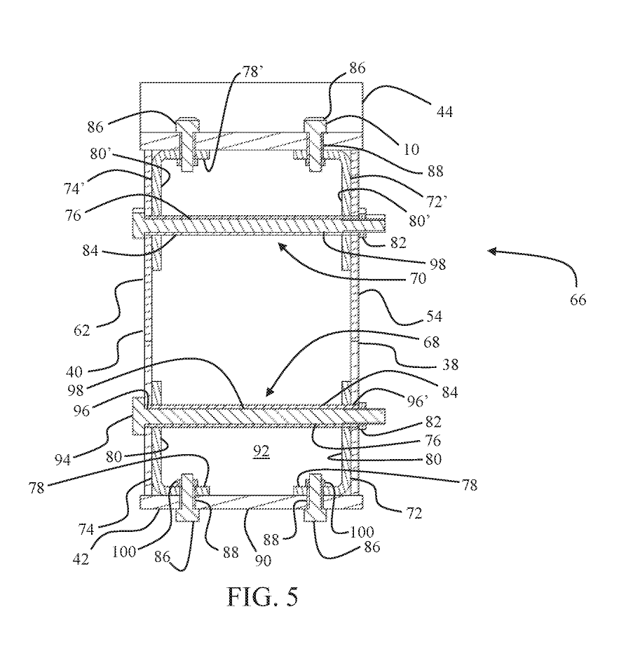

Referring to FIG. 4, an enlarged view of an end portion 64 of the first rail assembly 28 is shown. This end portion 64 is connectable to the rearward linkage 32 (FIG. 2) of the chassis frame 18. This view depicts an interlinked arrangement between the first side plate 38, the base plate 42, the second side plate 40, and the forward roof plate 44. More particularly, the view discloses a connection assembly 66 with a first bracket assembly 68 and a second bracket assembly 70 (best shown in FIG. 5) that facilitates formation of the interlinked arrangement. The first bracket assembly 68 is applied between a series formed by the first side plate 38, the base plate 42, and the second side plate 40, while the second bracket assembly 70 is applicable between a series formed by the second side plate 40, the forward roof plate 44, and the first side plate 38. Although not explicitly shown, a similar third bracket assembly exists between the first side plate 38, the rearward roof plate 46, and the second side plate 40 (FIG. 2), as well, and forms a part of the connection assembly 66. Although multiple bracket assemblies are disclosed, it may be contemplated that certain designs and configurations, such as those being defined by cuboidal configurations, of the chassis frame 18, may possess only a pair of bracket assemblies, and with the aspects of the present disclosure being equivalently applicable to such configurations.

Referring to FIG. 5, a cross-sectional view of the first rail assembly 28 along a section A-A (FIG. 4) is provided. The cross-sectional view depicts details pertaining to the connection assembly 66. Although the first bracket assembly 68 and the second bracket assembly 70 are discussed, it will be apparent that these discussions will be applicable to the third bracket assembly as well.

The first bracket assembly 68 is laid out between the first side plate 38, extending across the base plate 42, and is in connection with the second side plate 40. In so doing, a substantially rigid, right angled interlocked connection is formed between the plates 38 and 40. The first bracket assembly 68 includes a first L-shaped bracket 72, a second L-shaped bracket 74, and a set of retainer bolts or threaded fasteners 76.

The first L-shaped bracket 72 includes a first portion 78 and a second portion 80. The first portion 78 corresponds to the generally horizontal section of the L-shaped brackets 72 and 74, while the second portion 80 corresponds to the generally vertical section of the L-shaped brackets 72 and 74, The first portion 78 is connected to the base plate 42, while the second portion 80 is connected to the first side plate 38. The first L-shaped bracket 72 may be formed of a steel plate, for example, which is bent and formed into the desired shape to suit the spatial requirements between the plates 38 and 40. The second L-shaped bracket 74 is similar in form and function to the first L-shaped bracket 72 and facilitates connection between the second side plate 40 and the base plate 42. As with the first L-shaped bracket 72, the second L-shaped bracket 74 also includes the first portion 78 connecting to the base plate 42 and the second portion 80 connecting to the second side plate 40.

The set of threaded fasteners 76 refers to multiple threaded fasteners that are positioned sequentially along an expanse (length, L, see FIG. 2) of the first bracket assembly 68 and the second bracket assembly 70. Each threaded fastener 76 among the plurality of the threaded fasteners 76 is adapted to extend into the second side plate 40 and be routed out through the first side plate 38, and be secured by a nut 82 (see FIG. 5). For this purpose, a plurality of holes or apertures 96 (see FIG. 5) may be structured on the first side plate 38 and the second side plate 40 that allow passage of the threaded fasteners 76. More particularly, this extension is routed through the second portions 80 of both the first L-shaped bracket 72 and the second L-shaped bracket 74. In some embodiments, the set of threaded fasteners 76 may include solely a pair of threaded fasteners 76. The threaded fasteners 76 may be bolts, stud, etc., that are generally conventionally and widely available.

Each threaded fastener 76 includes a first sleeve 84. Each such first sleeve 84 is positioned with a minimum clearance around a shaft portion 98 of each of the threaded fasteners 76. When deployed, the first sleeve 84 extends from the first outer surface 54 of the first side plate 38 to the second outer surface 62 of the second side plate 40. Such a configuration of the sleeve 84 facilitates formation of an interface between each threaded fastener 76 and each of the first side plate 38 and the second side plate 40.

The first bracket assembly 68 includes an auxiliary set of threaded fasteners 86 which are extended into the base plate 42 and are routed through the first portions 78 of the L-shaped brackets 72 and 74 and secured by an auxiliary nut 100. This facilitates connection of the L-shaped brackets 72 and 74 to the base plate 42, and results in the angular connection of the first side plate 38 with the base plate 42, and the second side plate 40 with the base plate 42. Further, each threaded fasteners among the auxiliary set of threaded fasteners 86 includes an auxiliary sleeve or a second sleeve 88. As with the arrangement of the first sleeve 84, the second sleeve 88 is positioned about the shafts of each of the auxiliary set of threaded fasteners 86 and is extended from an outer surface 90 of the base plate 42 and inwardly into a volume 92 defined by the box-shaped first assembly 28. To this end, the second sleeve 88 forms an interface between the base plate 42 and each of the auxiliary set of threaded fasteners 86, as has been described of the first sleeve 84.

The second bracket assembly 70 assumes a form, arrangement, and function, similar to what has been described of the first bracket assembly 68. As with the L-shaped brackets 72 and 74 of the first bracket assembly 68, the second bracket assembly 70 also includes a first L-shaped bracket 72′ and a second L-shaped bracket 74′, and has similarly configured first portions 78′ connected to the forward roof plate 44. The connection between the first portions 78′ of the second bracket assembly 70 and the forward roof plate 44 is adapted by way of a second auxiliary set of threaded fasteners 86 that have a similar sleeve arrangement (such as the second sleeve 88), and the deployment and configurations of which remain similar to what has been described of the first set of the threaded fasteners 86.

Although the third bracket assembly, which connects the first rearward upper edge 52 to the second rearward upper edge 60, is not shown, it is contemplated that the third bracket assembly includes the same set of arrangements as has been discussed for the first bracket assembly 68 and the second bracket assembly 70. Moreover, the functional aspects of the third bracket assembly also remain same as have been discussed for the first bracket assembly 68 and the second bracket assembly 70.

### INDUSTRIAL APPLICABILITY

During operations, the chassis frame 18 may be subject to loading conditions that result in the sustenance of longitudinal torsion, vertical bending, fatigue loading, torsion loading, and lateral bending. Further, there are number of parameters which affect the fatigue life of the structure, such as cyclic stress state, geometry, surface quality, material type, residual stresses, size, and distribution of internal defects, direction of loading, etc. This is generally true for operations involving repeated raising and lowering of the dump body 16 by use of the hoist assembly 20, since portions, such as the frame portion 22, around the hoist assembly 20 generally remain prone to the receipt of a maximum degree of load, resulting in the structural deformation from weld failures etc. Over a period, it is quite normal to retire the chassis frame 18 to an overhaul and service.

With the given structural arrangement, an operator(s) may inspect the areas of the chassis frame 18 that has sustained the maximum damage during a service procedure. Given the subsequent need to repair, remove, or re-assemble a deformed part, the modular connection arrangement of the connection assembly 66, involving the use of threaded fasteners 76, make the service effort relatively easier, as compared to when welded and casted structures are applied. Quicker assembly time during a first time assembly or during a repair process, for example, may lead to increased production and commensurately higher revenue earnings.

Further, this design envisages the reinforcement of the chassis frame 18 by fastening the members of the chassis frame members together with brackets and conventionally available threaded fasteners, but in a way to impart strength, durability, and robustness, to the structure against lateral bending forces that enact during operations. For this purpose, the first sleeve 84 is provided as an interface and a barrier against an incoming load from the first side plate 38 and the second side plate 40, and thereby protecting the threaded fasteners 76 from considerable damage. Further, as welded connections are avoided, the structure remains free of the common limitations of weld-joints, such as weld variations and a general aesthetic appeal. Similar advantages is observable at the connection between the base plate 42 and the first portion 78, as a load sustained by the base plate is translated to the sleeves 88, while the fasteners remain protected. Owing to the sleeve-over-fastener arrangement, a torsional rigidity of the bolted chassis frame 18 is better as sleeves 84, 88 connect to the plates 38, 40, 42, and 44, and so a resistance to a twisting load is relatively significantly enhanced. Moreover, the threaded fasteners 76 act as retainers and are not subjected to a generally direct frame load.

During a general assembly process, an operator first secures the first portion 78 of the first L-shaped bracket 72 and the second L-shaped bracket 74 of the first bracket assembly 68 to the base plate 42. Thereafter, the first side plate 38 and the second side plate 40 is brought against the respective second portions 80 of the first L-shaped bracket 72 and the second L-shaped bracket 74. The operator then inserts the first sleeve(s) 84 into the threaded fasteners 76. The first sleeve 84 is generally inserted all the way to abut against a bolt head 94 of the threaded fasteners 76. Next, the operator inserts the threaded fasteners 76 into the second side plate 40 through aperture 96. Then, the operator draws the threaded fastener 76 through the second portions 80 of the both the first L-shaped bracket 72 and the second L-shaped bracket 74. Thereafter, the threaded fasteners 76 are routed further into the first side plate 38 and drawn beyond the first outer surface 54 of the first side plate 38. An extended portion of the threaded fastener is then secured by a nut 82. The operator ensures that as this process is underway and accomplished, the first sleeve 84 occupies a position that forms an interface between the threaded fastener and each of the first side plate 38 and the second side plate 40. In so doing, the first sleeve 84 is allowed to divert a considerable degree of load of the dump body 16 from the threaded fasteners 76, during operations. As a result, the threaded fasteners 76 are protected from the cyclical stresses of operation and relatively short-life fatigue failures.

It should be understood that the above description is intended for illustrative purposes only and is not intended to limit the scope of the present disclosure in any way. Thus, one skilled in the art will appreciate that other aspects of the disclosure may be obtained from a study of the drawings, the disclosure, and the appended claim.

What is claimed is:

1. A chassis frame for a machine, the chassis frame comprising:
a rail assembly including:
a first side plate with a first outer surface;
a base plate angularly connectable with the first side plate;
a second side plate with a second outer surface, the second side plate being angularly connectable to the base plate and being positioned relatively parallely and symmetrically oppositely to the first side plate, across the base plate;
one or more roof plates angularly connectable with the second side plate and the first side plate, and imparting a substantially closed, box-shaped profile to the side rail assembly;
a connection assembly facilitating connection between the first side plate, the base plate, the second side plate, and the one or more roof plates, the connection assembly including:
at least one first bracket assembly;
at least one second bracket assembly, with each of the at least one first bracket assembly and the at least one second bracket assembly including first portions and second portions, wherein first portions of each of the at least one first bracket assembly and the at least one second bracket assembly connect to one of the base plate and the one or more roof plates; and
at least a pair of threaded fasteners, with each threaded fastener among the at least a pair of threaded fasteners extending into the second side plate and being routed through the first side plate respectively through the second portions of each of the at least one first bracket assembly and the at least one second bracket assembly, with each threaded fastener including:
a sleeve positioned about each threaded fastener and extending from the first outer surface of the first side plate to the second outer surface of the second side plate, forming an interface respectively between each threaded fastener and the first side plate and the second side plate.

2. The chassis frame of claim 1, wherein a connection of the first portions of each of the at least one first bracket assembly and the at least one second bracket assembly to one of the base plate and the one or more roof plates is facilitated by an auxiliary pair of threaded fasteners. The chassis frame of claim 2, wherein each threaded fastener among the auxiliary pair of threaded fasteners include an auxiliary sleeve, that forms an interface and separates each threaded fastener among the auxiliary pair of threaded fasteners from one of the base plate and the one or more roof plates.
